(19) United States
(12) Patent Application Publication
(10) Pub. No.: US 2003/0206375 A1
(43) Pub. Date: Nov. 6, 2003

(54) Magnetic head device and flexible disc device using the same

(76) Inventors: Katsuaki Kanaya, Yokohama-shi (JP); Hiroshi Nishizawa, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/424,867

(22) Filed: Apr. 29, 2003

(30) Foreign Application Priority Data
May 1, 2002 (JP) 2002-130042

(51) Int. Cl. G11B 5/48

(52) U.S. Cl. 360/241.2

(57) ABSTRACT

A magnetic head device and a flexible disc device using the same are disclosed. In the disclosed arrangement, a deformation of a gimbal spring caused by an impact is prevented, thereby providing a magnetic head and a flexible disc having a high reliability. In a a double side type magnetic head in which one magnetic head placed on at least upper side of a disc is supported by a gimbal spring in a shape of a flat plate that can be torsionally displaced in two axes, for a linking unit which can be torsionally displaced around an axis, at least one regulator which has a small torsional rigidity and regulates a torsional displacement in the linking unit is placed at a position distant from the linking unit, and this regulator keeps the displacement in the linking unit in an elastic region to thereby prevent a plastic deformation and improve an impact resistance.

### BACKGROUND OF THE INVENTION

1. Field of the Invention

The present invention relates to a magnetic head device used in a memory of a personal computer or the like, and a flexible disc device using the same. More particularly, the present invention relates to a structure to improve an impact resistance of a magnetic head device.

2. Description of the Related Art

This type of a conventional magnetic head device is disclosed in Japanese Laid Open Patent Application (JP-A-Heisei, 9-134577), Japanese Laid Open Patent Application (JP-A-Heisei, 5-94609) and the like. Japanese Laid Open Patent Application (JP-A-Heisei, 9-134577) discloses a device, which couples an elastic member to a portion except a junction of a gimbal spring and thereby improves an impact resistance. Also, Japanese Laid Open Patent Application (JP-A-Heisei, 5-94609) discloses a device, which places a controller for controlling a vibration of a gimbal spring at an end of a flexible substrate and thereby controls the vibration.

However, those conventional magnetic head device has the problems that the work for coupling the elastic member to the portion except the junction of the gimbal sparing in order to improve the impact resistance is troublesome and that the coupling is sometimes insufficient and it is thereby separated. Moreover, this has the problem that the variation in the work obstructs the follow-up performance on the magnetic head at a time of a recording/reproducing operation to thereby bring about an error and the like. Also, this device has the following problems. That is, because of the controller placed at the end of the flexible substrate, the number of the flexible substrate installations is reduced, and the cost is raised. Also, when a soldering operation to a terminal of the magnetic head is carried out, the work is obstructed, and the deformation is induced. Thus, in order to obtain the necessary damping action, a bending work, an operation for repairing a bad quirk and the like are increased.

Also, miniaturization has been advanced in an apparatus such as a recent personal computer and the like. The opportunity that it is carried is increased. Consequently, in a case of a portable type such as a note type of a personal computer, it requires an impact resistance equal to or stronger than that of the conventional technique. Thus, even a floppy (R) disc device (also referred to as a flexible disc device) installed in the above-mentioned apparatuses requires the further improvement of the impact resistance.

In view of the above-mentioned problems, it is therefore an object of the present invention to provide a magnetic head device that has a good working performance and a high reliability and can improve an impact resistance without any increase in a cost, and a flexible disc device using the same.

### SUMMARY OF THE INVENTION

A magnetic head device of the present invention is a double side type magnetic head device in which at least one of a plurality of magnetic heads placed on upper and lower sides of a disc is supported by a gimbal spring in a shape of a flat plate that can be torsionally displaced in two axes,

wherein for a linking unit, which can be torsionally displaced around an axis, for linking any of a movable unit, a relaying unit and a fixing unit of the gimbal spring, regulating means which has a small torsional rigidity and regulates a torsional displacement amount in the linking unit is placed at a position distant from the linking unit, and the regulating means keeps the torsional displacement amount in the linking unit in an elastic region.

Due to this configuration, even if impact is applied from an external portion, the displacement in the linking unit does not reach a plastic region. Thus, it can be designed that the pose of the magnetic head is not changed. Hence, it is possible to prevent the deterioration in the property of the magnetic head device. Also, the regulating means is configured so as to be small in the torsional rigidity. Thus, the follow-up performance on the magnetic head is never obstructed. Hence, the property of the recording/reproducing operation is never deteriorated.

According to another feature of the present invention, in the magnetic head device of the present invention, the regulating means is constituted as a part of the gimbal spring, with regard to the magnetic head device mentioned in the above.

According to this configuration, since it can be produced by the process for producing the gimbal spring, the cost is not raised, and the number of the parts is not increased. Thus, the cost to manage the process is not required. Moreover, a work for installing a different part is not induced. Hence, it is possible to reduce the variation in the property and the defect in association with the assembling operation.

According to another feature of the present invention, in the magnetic head device of the present invention, the regulating means is placed at a position at which a phase is opposite to each of the linking units to the two axes, with regard to the magnetic head device mentioned in the above.

This configuration enables the regulating means to be placed on both sides of the head around the respective axes. Thus, the orientation can be provided to the impact resistance against impact. In short, the impact resistance in the direction where a pose is easy to change can be further improved against applied impact. By the way, due to this configuration, the surface on which the head is installed can be bent, and the stress on the head is suppressed. Hence, it is possible to reduce the influence on the magnetic property.

According to another feature of the present invention, in the magnetic head device of the present invention, the regulating means is placed at a position at which a phase is equal to each of the linking units to the two axes, with regard to the magnetic head device mentioned in the above.

Due to this configuration, the regulating means which are located in the same direction as the head around the respect axes and have the same property can be arranged at the positions symmetrical to each other. Due to this arrangement, the balance with regard to the follow-up performance can be easily attained. Also, the discrimination between the front and the rear of the gimbal spring can be unnecessary when it is assembled, which leads to the improvement of the working performance and thereby enables the drop in the cost.

According to another feature of the present invention, in the magnetic head device of the present invention, a viscid elastic unit is added to the regulating means, with regard to the magnetic head device mentioned in the above.

Due to this configuration, the damping performance can be improved in addition to the impact resistance. Thus, the unnecessary vibration from the disc can be suppressed to thereby obtain the stable contact condition with the disc.

According to another feature of the present invention, in the magnetic head device of the present invention, the center of the gravity of the placed magnetic head is flatly placed in a range surrounded with the regulating means and the linking unit, with regard to the magnetic head device mentioned in the above.

Due to this configuration, the magnetic head can be surely supported irrespective of the displacement of the magnetic head. Hence, the stress on the magnetic head caused by the impact can be reduced.

According to another feature of the present invention, in the magnetic head device of the present invention, a magnetic head placed on a lower side is installed in such a way that its rigidity is sufficiently high, with regard to the magnetic head device mentioned in the above.

Due to this configuration, the pose of the lower head is not changed by the impact. Thus, the stable contact with the disc can be obtained to thereby improve the reliability.

According to another feature of the present invention, a flexible disc device is a magnetic head device for sandwiching a flexible disc between both sides and carrying out a recording/reproducing operation, including: a double side type magnetic head device in which at least one of a plurality of magnetic heads placed on upper and lower sides of a disc is supported by a gimbal spring in a shape of a flat plate that can be torsionally displaced in two axes; a moving unit for moving the magnetic head to a tracking direction; and a motor for rotating and driving the disc,

wherein for a linking unit, which can be torsionally displaced around an axis, for linking any of a movable unit and a fixing unit of the gimbal spring, regulating means which has a small torsional rigidity and regulates a torsional displacement amount in the linking unit is placed at a position distant from the linking unit, and the regulating means keeps the torsional displacement amount in the linking unit in an elastic region.

Due to this configuration, even if the impact is applied from the external portion, the displacement in the linking unit does not reach the plastic region. Thus, it can be designed that the pose of the magnetic head is not changed. Hence, it is possible to prevent the deterioration in the property of the magnetic head device. Moreover, the impact resistance of the flexible disc device can be attained without any increase in the cost. Also, the regulating means is configured so as to be small in the torsional rigidity. Thus, the follow-up performance on the magnetic head is never obstructed. Hence, the reliability of the flexible disc device can be improved without any deterioration in the property of the recording/reproducing operation.

According to another feature of the present invention, in the flexible disc device of the present invention, the regulating means is constituted as a part of the gimbal spring, with regard to the flexible disc device mentioned in the above.

According to this configuration, since it can be produced by the process for producing the gimbal spring, the cost is not raised, and the number of the parts is not increased. Thus, the cost to manage the process is not required. Moreover, a work for installing a different part is not induced. Hence, it is possible to attain the flexible disc device, which can reduce the variation in the property and the defect in association with the assembling operation to thereby drop the cost and improve the reliability.

According to another feature of the present invention, in the flexible disc device of the present invention, the regulating means is placed at a position at which a phase is opposite to each of the linking units to the two axes, with regard to the flexible disc device mentioned in the above.

This configuration enables the regulating means to be placed on both sides of the head around the respective axes. Thus, the orientation can be provided to the impact resistance against the impact. In short, the impact resistance in the direction where the pose is easy to change can be further improved against the applied impact. By the way, due to this configuration, the surface on which the head is installed can be bent, and the stress on the magnet head is suppressed. Hence, it is possible to attain the flexible disc device, which can reduce the influence on the magnetic property and prevent the error from occurring in the recording/reproducing operation and thereby improve the reliability.

According to another feature of the present invention, in the flexible disc device of the present invention, the regulating means is placed at a position at which a phase is equal to each of the linking units to said two axes, with regard to the flexible disc device mentioned in the above.

Due to this configuration, the regulating means which are located in the same direction as the head around the respect axes and have the same property can be arranged at the positions symmetrical to each other. Due to this arrangement, the balance with regard to the follow-up performance can be easily attained. Thus, it is possible to attain the flexible disc device that does not require the discrimination between the front and the rear of the gimbal spring when it is assembled, which leads to the improvement of the working performance and thereby enables the drop in the cost.

According to another feature of the present invention, in the flexible disc device of the present invention, a viscid elastic unit is added to the regulating means, with regard to the flexible disc device mentioned in the above.

Due to this configuration, the damping performance can be improved in addition to the impact resistance. Thus, the unnecessary vibration from the disc can be suppressed to thereby obtain the stable contact condition with the disc. Hence, it is possible to attain the flexible disc device which can prevent the error from occurring in the recording/reproducing operation and thereby improve the reliability.

According to another feature of the present invention, in the flexible disc device of the present invention, the center of the gravity of the placed magnetic head is flatly placed in a range surrounded with the regulating means and the linking unit, with regard to the flexible disc device mentioned in the above.

Due to this configuration, the magnetic head can be surely supported irrespective of the displacement of the magnetic head. Thus, the stress on the magnetic head caused by the impact can be reduced to thereby improve the reliability of the flexible disc device.

According to another feature of the present invention, in the flexible disc device of the present invention, a magnetic head placed on a lower side is installed in such a way that its rigidity is sufficiently high, with regard to the flexible disc device mentioned in the above.

Due to this configuration, the pose of the lower head is not changed by the impact. Thus, the stable contact with the disc can be obtained to thereby prevent the error from occurring in the recording/reproducing operation. Hence, it is possible to attain the flexible disc device having the improved reliability.

According to another feature of the present invention, in the flexible disc device of the present invention, a magnetic permeability of the gimbal spring is 1.5 or less, with regard to the flexible disc device mentioned in the above.

This configuration substantially disables a magnetic noise to be induced from an external portion. Thus, it is possible to attain the flexible disc device which can prevent the error from occurring and thereby improve the reliability.

According to another feature of the present invention, in the flexible disc device of the present invention, the gimbal spring is made of beryllium copper, with regard to the flexible disc device mentioned in the above.

This configuration surely enables the magnetic permeability of the gimbal spring to be 1.5 or less, which substantially disables the magnetic noise to be induced from the external portion. Thus, the occurrence of the error can be prevented to thereby improve the reliability. By the way, as compared with phosphor bronze, the durability is high. Hence, it is possible to attain the flexible disc device which can reserve the sufficient reliability even against the impact.

According to another feature of the present invention, in the flexible disc device of the present invention, the gimbal spring has a thickness of 0.1 mm or less which is etched or pressed, with regard to the flexible disc device mentioned in the above.

This configuration enables the gimbal spring to be cheap and also enables the follow-up performance on the disc to be high. Thus, it is possible to attain the flexible disc device which can prevent the error from occurring and thereby improve the reliability.

### BRIEF DESCRIPTION OF THE DRAWINGS

These and other objects and features will become more readily apparent from the following detailed description taken in conjunction with the accompanying drawings in which:

FIG. 1A is a perspective view showing a magnetic head placed on an upper side in an embodiment of the present invention in such a way that upper and lower portions thereof are reversed;

FIG. 1B is a plan view enlarging and showing a part of FIG. 1A;

FIG. 2 is a plan view showing a main portion of FDD in an embodiment of the present invention;

FIG. 3 is a perspective view showing a main portion of FD in an embodiment of the present invention;

FIG. 4 is a plan view showing a carriage assembly in an embodiment of the present invention;

FIG. 5 is a property view showing a relation between an impact value and a change amount in an alignment in FDD in an embodiment of the present invention; and

FIG. 6 is a property view showing a relation between a magnetic permeability of a gimbal spring and an error rate in FDD in an embodiment of the present invention.

### DETAILED DESCRIPTION OF THE PREFERRED EMBODIMENTS

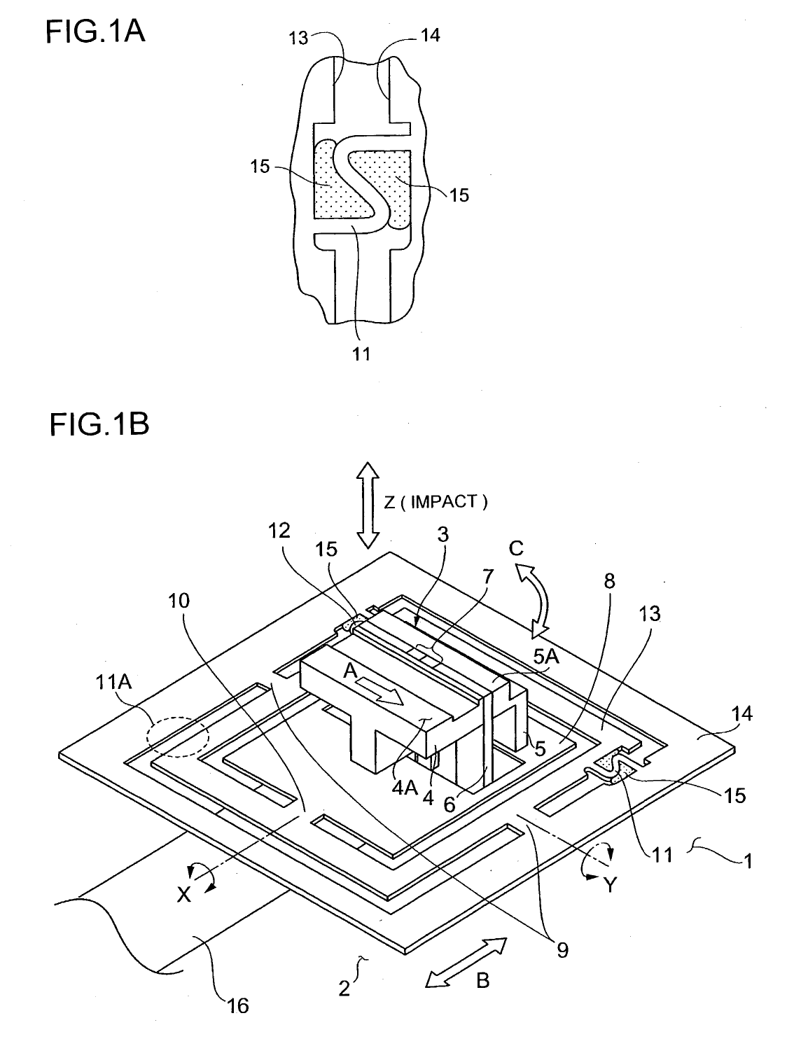

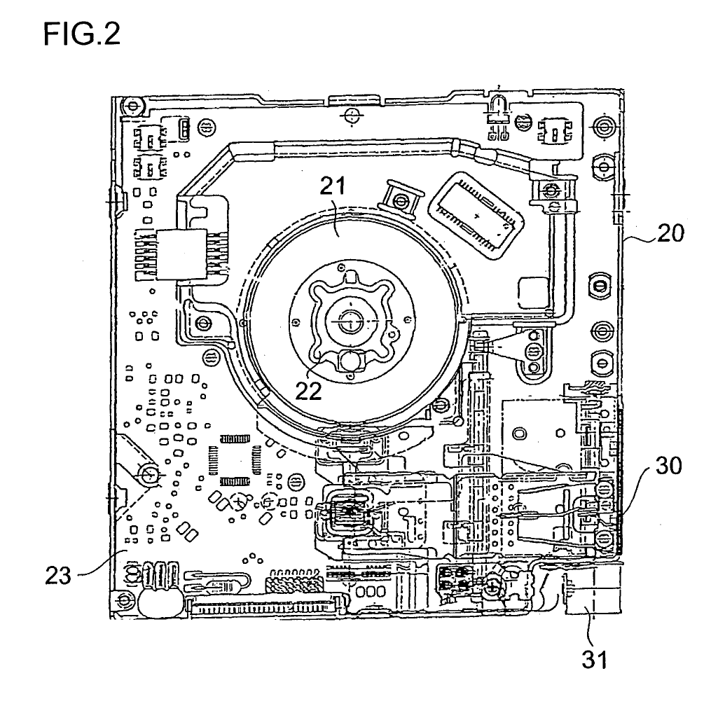

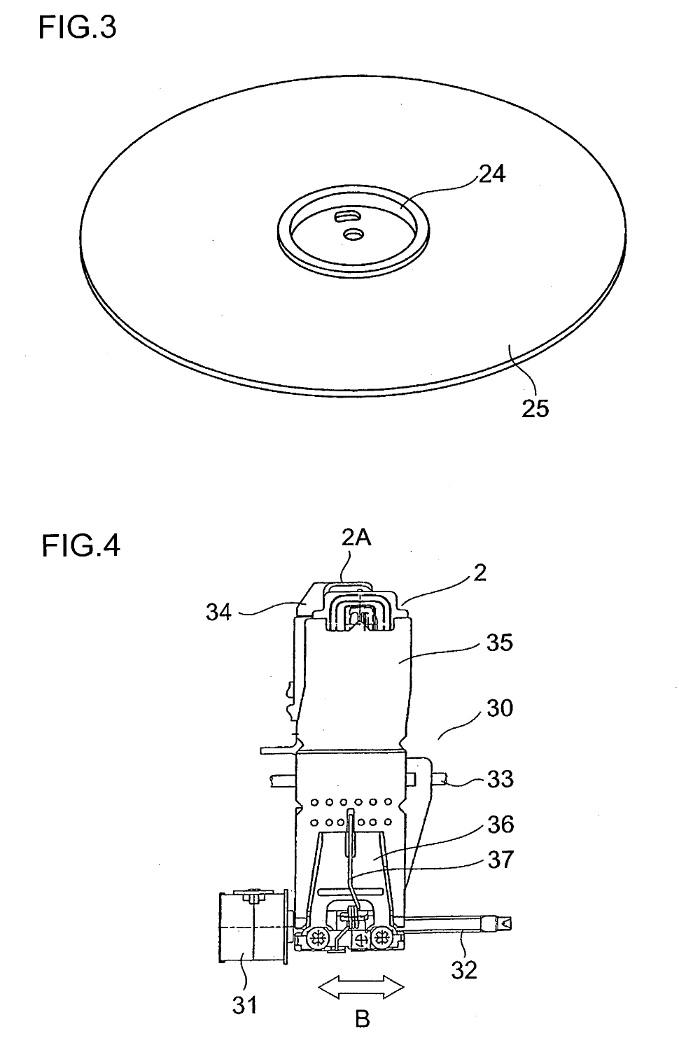

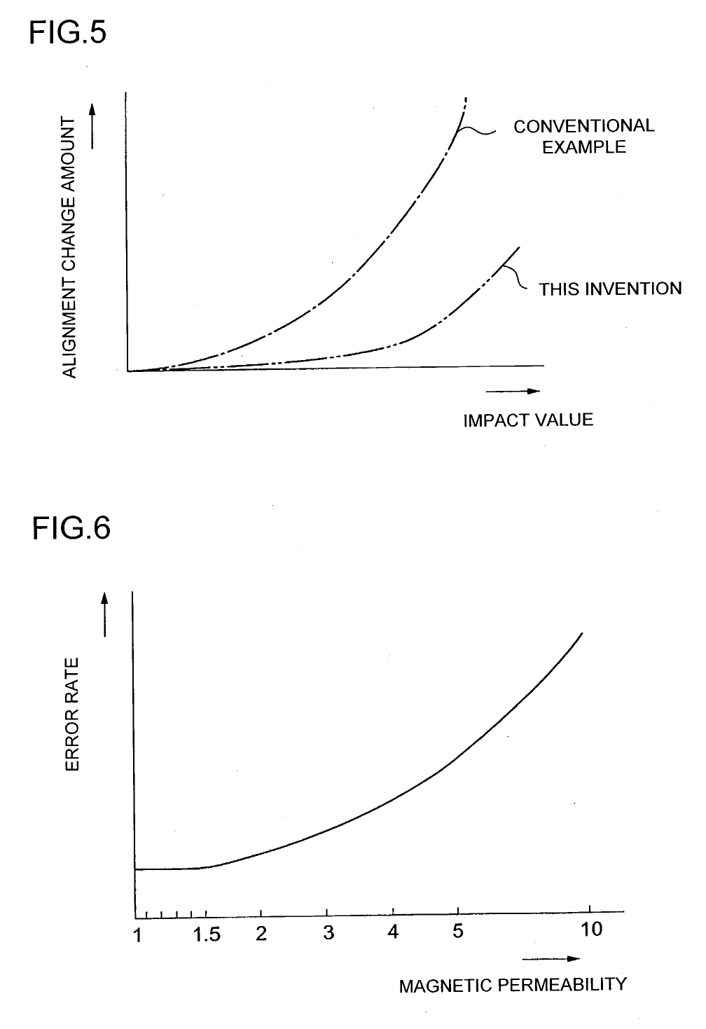

An embodiment according to the present invention will be described below with reference to FIGS. 1A to 6. FIG. 1A is a perspective view showing a magnetic head placed on an upper side in an embodiment of the present invention, and FIG. 1B is a plan view enlarging and showing a part thereof. FIG. 2 is a plan view showing a main portion of a flexible disc device (hereafter, abbreviated as FDD) as an embodiment of the present invention. FIG. 3 is a perspective view showing a main portion of a flexible disc (hereafter, abbreviated as FD) serving as a magnetically recording medium to which the embodiment of the present invention is applied. FIG. 4 is a plan view showing a carriage assembly including the magnetic head in the present invention. FIG. 5 is a property view showing the relation between an impact value and a change amount in an alignment in the FDD of the present invention. And, FIG. 6 is a property view showing the relation between a magnetic permeability of a gimbal spring and an error rate in the FDD of the present invention.

FIG. 1A is the perspective view showing the magnetic head placed on the upper side of a disc, in such a way that the upper and lower portions thereof are reversed for the purpose of easy explanation. FIG. 1B is the plan view enlarging and showing the part of FIG. 1A. As shown in FIG. 1A, a magnetic head assembly 1 is provided with a magnetic head body 3 and a gimbal spring 2. Sliders 4, 5 where slider planes 4A, 5A in contact with the FD (not shown) are respectively placed are placed on the upper portion. A magnetic core 6 is sandwiched between them, and the magnetic head body 3 is assembled. A magnetic gap 7 to record and reproduce a data to and from the FD is placed in the magnetic core 6 and exposed on the slider planes 4A, 5A. In this embodiment, ferrite in Mn—Zn system is used for the magnetic core 6, and ceramic in calcium titanate system is used for the sliders 4, 5. The magnetic head body 3 is fixed through proper adhesive to the gimbal spring 2. Also, an arrow A in FIG. 1A indicates a running direction of the FD.

In order to fix the magnetic head body 3, the gimbal spring 2 is composed of: a flat surface 8 serving as a movable unit that is an inner portion of the gimbal spring 2; a fixing unit 14 located at an outer portion so as to be fixed to an arm 35 which will be described later; and a relaying unit 13 located at the middle between them. The flat surface 8 is configured so as to have a free degree for a torsion direction through tiebars 9, 10 serving as linking units which are placed at the relaying unit 13 with respect to the fixing unit 14 so that the magnetic gap 7 always has the good contact condition with the FD. The tiebar 9 has a free degree mainly for a roll direction (a direction indicated by an arrow Y in FIG. 1A) of the FD, and the tiebar 10 has a free degree mainly for a pitch direction (a direction indicated by an arrow X in FIG. 1A) of the FD.

The respective tiebars 9, 10 are placed at the substantial center between the flat surface 8 and the fixing unit 14 and configured so as to provide the similar torsion rigidities for the respective directions (CW and CCW) of the roll and the pitch. Regulators 11, 12 serving as regulating units or regulating means in this embodiment are placed at the positions (the external direction) away from the tiebar 9, as shown in FIG. 1B. Their lengths are equal to or longer than 1.5 times that of the tiebar 9, and their width are half or less. They are substantially S-shaped, and they are designed to have the torsion rigidities smaller than that of the tiebar 9. By the way, since the regulators 11, 12 are substantially S-shaped, their torsion rigidities are smaller irrespectively of narrow space, and the follow-up performance on the magnetic head is not obstructed. Also, in the regulators 11, 12, a proper amount of a viscid elastic unit 15 is coated on the gap of the S-shaped portion. In this case, desirably, variation does not occur in the coated amount. As the viscid elastic unit 15, the resin that does not lose its elasticity and the other properties even after it is cured can be used, such as silicon-based resin, synthetic rubber-based resin and the like. Coating the viscid elastic unit 15 can increase the damping effect, which will be described later, and can further provide the effect as the damping member for the S-shaped portion. In this embodiment, the gimbal spring 2 is made of beryllium copper and produced by pressing a plate with a thickness of 0.05 mm and punching out a flat plate and then carrying out a proper heating process. A flexible cable 16 is intended to transmit and receive an electronic signal between a circuit of a main body and a coil of a magnetic head (not shown). Also, an arrow B in FIG. 1A indicates a tracking direction (a radius direction) of the FD.

The FDD will be described below with reference to FIGS. 2 and 3. In the FDD of FIG. 2, the magnetic head is installed to a chassis 20 and provided with: a head carriage assembly 30 assembled so as to hold the FD; a step motor 31 for moving this head carriage assembly 30 in the tracking direction of the FD; and a circuit board 23 on which the necessary electric parts, such as a spindle motor 21 having a chucking unit 22 for rotationally driving the FD, a control LSI and the like are mounted. In accordance with the control signal from an external portion (not shown), the spindle motor 21 is rotated or stopped, and the head carriage assembly 30 is moved to a required track, and a recording/reproducing operation is carried out. In FIG. 3, at the center of the FD, there is a core mandrel 24 corresponding to the chucking unit 22, and a magnetically recording medium 25 in which PET (poly-ethylene terephthalate) is used as a base material is attached to the core mandrel 24.

FIG. 4 shows in detail the relation between the head carriage assembly 30 and the step motor 31. In FIG. 4, a magnetic head at a lower portion is fixed to a tip of a carriage 34 through a stainless fixing plate 2A having a high rigidity. An upper magnetic head is fixed through the gimbal spring 2 to the tip of the arm 35 placed on the upper side of the FD, and it can be displaced in the roll pitch directions. A base unit is fixed to a base unit of the carriage 34 through a thin plate spring referred to as a pivot 36. This pivot 36 enables the magnetic head to be rotated while it is in contact with the FD or not in contact. A load spring 37 pushes the arm 35 against the side of the carriage 34 at a necessary load so that the stable contact can be obtained between the FD and the magnetic head. The carriage 34 can be moved in the tracking direction (the directions indicated by the arrows B of FIG. 1A and FIG. 4) by a lead screw 32 attached to the step motor 31 and a guide bar referred to as a guide rod 33.

The operation will be described below. The FD is adhered and fixed to the core mandrel by coating a magnetic material on a flexible board. Thus, it is rotated while slightly displaced in the thickness direction thereof. On the contrary, this is designed so as to push the magnetic head from both sides to thereby maintain the contact. Moreover, since the magnetic head placed on the upper side has the free degree for the roll and pitch directions, it can follow this displacement of the FD. The conventional device having no regulators 11, 12 will be described below with reference to FIGS. 1A and 1B. When impact is applied to the direction indicated by an arrow Z of FIG. 1A, the mass of the magnetic head causes the magnetic head to be rotated in the direction indicated by an arrow C of FIG. 1A. Consequently, a load is applied to a torsion direction of the tiebar 9.

Now, if the stress generated by this load exceeds the allowable stress in the tiebar, it reaches a plastic region to thereby bring about a deformation. This deformation may break the balance of the load in the upper and lower magnetic heads or change the follow-up performance in the roll direction. This results in the increase in the frequency of the error occurrences in the conventional recording/reproducing operation. Moreover, this results in the change in the position of the upper magnetic gap which is precisely arranged. Thus, the position with respect to a track is changed at the level equal to or greater than an allowable amount, which may disable the recording/reproducing operation.

In this embodiment, the regulators 11, 12 are configured such that the tiebar 9 is displaced within an elastic region. Thus, this can prevent the tiebar 9 from being plastically deformed. Actually, the tiebar 9 is considered to be plastically deformed if a rotational angle in the direction indicated by the arrow C of FIG. 1A is 10° or more. Thus, the displacement of the tiebar 9 allowed by the regulators 11, 12 is set to be less than 10° at the rotational angle.

Although the tiebar 9 is torsionally deformed, the regulators 11, 12 are operated such as a tension spring. As for its length, it is S-shaped and longer than that of the tiebar 9. Thus, its tension stress can be small. Also, the regulators 11, 12 are small in torsion rigidity against the tiebar 9. Thus, the follow-up performance to the FD is never reduced. Moreover, due to the viscid elastic unit 15 coated on the regulators 11, 12, the magnetic head body 3 and the magnetic head assembly 1 convert the kinetic energy of the unnecessary vibration transmitted from the FD into the thermal energy. Thus, the excellent damping property can be provided to thereby reduce even the error occurrence. By the way, the heat generation caused by the conversion as the thermal energy is very little. The impact direction in which the problem of the increase in the temperature is never induced is explained by exemplifying the direction indicated by the arrow Z of FIG. 1A. However, it is evidently possible to cope with even a different direction by installing the similar regulator.

Also, in this embodiment, the regulators 11, 12 are arranged at the substantially same positions in the longitudinal direction of the slider with respect to the tiebar 9. Thus, the regulators 11, 12 follow the flat surface of the gimbal spring 2 at the simultaneously same phases. Due to this configuration, the regulators which are located in the same direction as the magnetic head around the respect axes and have the same property can be arranged at the positions symmetrical to each other. Due to this arrangement, the balance with regard to the follow-up performance can be easily attained. Also, the discrimination between the front and the rear of the gimbal spring 2 can be unnecessary when it is assembled, which leads to the improvement of the working performance and thereby enables the drop in the cost. Also, it can be arranged at the position whose phase is opposite (11A of FIG. 1A).

In this case, since the regulators 11, 12 can be arranged in the directions of the diagonal lines of the heads around the respective axes, the orientation can be provided to the impact resistance against impact. In short, the impact resistance in the direction where a pose is easy to change can be further improved against applied impact. Namely, due to the existence of FPC to transmit and receive an electric signal to and from the magnetic head, the effect can be suitably changed depending on the direction where the pose is easy to change against the impact. Thus, the free degree of a design can be increased. Also, the center of the gravity of the installed magnetic head is flatly arranged in the range surrounded with the tiebar 9 and the regulators 11, 12. Thus, the magnetic head can be surely supported irrespective of the displacement of the magnetic head. Hence, the stress on the magnetic head caused by the impact can be reduced, and the magnetic property of the magnetic core 6 is never changed. Consequently, since the electromagnetic conversion property is never changed, it is possible to prevent the deterioration in the recording/reproducing property. By the way, as mentioned above, the lower magnetic head is fixed to the tip of the carriage through the stainless fixing plate having the high rigidity. Hence, the pose of the lower magnetic head is never changed by the impact. Hence, it is possible to prevent the deterioration in the recording/reproducing property.

The FDD of a second embodiment of the present invention will be described below with reference to FIGS. 5 and 6. FIG. 5 is a property view showing the relation between an impact value and a change amount of an alignment in the FDD of the present invention. The alignment designates a positional precision (a radial alignment) with respect to the radius direction of the FD. The FDD is designed such that the respective precisions are distributed to the respective members in order to insure the compatibility with the FD. When a positional deviation (referred to as an off-track) between the radius direction of the magnetic head (accurately, the magnetic core) and the track position of the FD becomes an allowable value or more in the necessary track, the frequency of the error occurrences at the time of the reading operation is increased. Moreover, it is known that the increase in the deviation disables the reading operation. For this reason, a positional adjustment is usually performed on the magnetic head.

In FIG. 5, it is understood that in the FDD according to the present invention, the alignment change amount with respect to the applied impact value is decreased over the conventional example. That is, according to the present invention, it is possible to improve the impact resistance of the FDD and reduce the read error and thereby improve the reliability. FIG. 6 is a property view when a switching power supply as an electromagnetic noise source is placed near the FDD to then measure the relation between the magnetic permeability of the gimbal spring and the error rate. From this property view, it is understood that the error rate to the electromagnetic noise from an external portion is increased from the vicinity of the magnetic permeability of 2. In the present invention, since the magnetic permeability is set to 1.5 or less, the increase in the error can be prevented. By the way, the gimbal spring 2 uses the beryllium copper having a large volume resistance. Thus, it is possible to confirm the drop in the eddy current generated by the magnetic flux crossing the thickness direction of the gimbal spring 2. This implies that the increase in the error rate can be prevented since the configuration of one-turn coil through the gimbal spring 2 magnetically biases the magnetic core.

As mentioned above, according to the present invention, the improvement of the impact resistance in the FDD can be surely attained without any increase in the cost. By the way, it is evident that the above-mentioned embodiment can be suitably modified.

As evident from the above-mentioned embodiment, the present invention is designed such that the magnetic head placed at the upper portion is supported by the gimbal spring which can be torsionally displaced in the two axes, and the regulators for regulating the displacement in the small torsional rigidity are placed at the distant positions, for the linking unit which can be torsionally displaced, and the displacement in the linking unit is held in the elastic region. Due to this configuration, even if the impact is applied from the external portion, the displacement in the linking unit does not reach the plastic region. Thus, it can be designed that the pose of the magnetic head is not changed. Thus, it is possible to prevent the deterioration in the property of the magnetic head device. Also, the regulator is configured so as to be small in the torsional rigidity. Hence, the follow-up performance on the magnetic head is never obstructed. Hence, the property of the recording/reproducing operation is never deteriorated.

What is claimed is:

1. A double side type magnetic head device in which at least one of a plurality of magnetic heads placed on upper and lower sides of a disc is supported by a gimbal spring in a shape of a flat plate that can be torsionally displaced in two axes,
wherein for a linking unit, which can be torsionally displaced around an axis, for linking any of a movable unit, a relaying unit and a fixing unit of said gimbal spring, regulating means which has a small torsional rigidity and regulates a torsional displacement amount in said linking unit is placed at a position distant from said linking unit, and said regulating means keeps the torsional displacement amount in said linking unit in an elastic region.

2. The magnetic head device according to claim 1, wherein said regulating means is constituted as a part of said gimbal spring.

3. The magnetic head device according to claim 1, wherein said regulating means is placed at a position at which a phase is opposite to each of said linking units to said two axes.

4. The magnetic head device according to claim 1, wherein said regulating means is placed at a position at which a phase is equal to each of said linking units to said two axes.

5. The magnetic head device according to any one of claims 2 to 4, wherein a viscid elastic unit is added to said regulating means.

6. The magnetic head device according to any one of claims 1 to 4, wherein the center of the gravity of said placed magnetic head is flatly placed in a range surrounded with said regulating means and said linking unit.

7. The magnetic head device according to any one of claims 1 to 4, wherein a magnetic head placed on a lower side of said disc is installed in such a way that its rigidity is sufficiently high.

8. A flexible disc device for sandwiching a flexible disc between both sides and carrying out a recording/reproducing operation, including: a double side type magnetic head device in which at least one of a plurality of magnetic heads placed on upper and lower sides of a disc is supported by a gimbal spring in a shape of a flat plate that can be torsionally displaced in two axes; a moving unit for moving said magnetic head to a tracking direction; and a motor for rotating and driving said disc,
wherein for a linking unit, which can be torsionally displaced around an axis, for linking any of a movable unit and a fixing unit of said gimbal spring, regulating means which has a small torsional rigidity and regulates a torsional displacement amount in said linking unit is placed at a position distant from said linking unit, and said regulating means keeps the torsional displacement amount in said linking unit in an elastic region.

9. The flexible disc device according to claim 8, wherein said regulating means is constituted as a part of said gimbal spring.

10. The flexible disc device according to claim 8, wherein said regulating means is placed at a position at which a phase is opposite to each of said linking units to said two axes.

11. The flexible disc device according to claim 8, wherein said regulating means is placed at a position at which a phase is equal to each of said linking units to said two axes.

12. The flexible disc device according to any one of claims 9 to 11, wherein a viscid elastic unit is added to said regulating means.

13. The flexible disc device according to any one of claims 8 to 11, wherein the center of the gravity of said placed magnetic head is flatly placed in a range surrounded with said regulating means and said linking unit.

14. The flexible disc device according to any one of claims 8 to 11, wherein a magnetic head placed on a lower side of said disc is installed in such a way that its rigidity is sufficiently high.

15. The flexible disc device according to one of the preceding claims 8 to 11, wherein a magnetic permeability of said gimbal spring is 1.5 or less.

16. The flexible disc device according to claim 15, wherein said gimbal spring is made of beryllium copper.

17. The flexible disc device according to claim 15 or 16, wherein said gimbal spring has a thickness of 0.1 mm or less which is etched or pressed.
